(19) United States
(12) Patent Application Publication
(10) Pub. No.: US 2014/0049902 A1
(43) Pub. Date: Feb. 20, 2014

(54) MOUNTING DEVICE FOR HARD DISK DRIVE

(71) Applicant: LEI LIU, Shenzhen City (CN)

(72) Inventor: LEI LIU, Shenzhen City (CN)

(73) Assignees: HON HAI PRECISION INDUSTRY CO., LTD., Tu-Cheng (TW); HONG FU JIN PRECISION INDUSTRY (ShenZhen) Co., LTD., Shenzhen City (CN)

(21) Appl. No.: 13/593,481

(22) Filed: Aug. 23, 2012

(30) Foreign Application Priority Data
Aug. 14, 2012 (CN) 2012102878558

(51) Int. Cl. G06F 1/16

(52) U.S. Cl. 361/679.33

(57) ABSTRACT

A mounting device for mounting a hard disk drive (HDD) includes a motherboard forming a memory slot, a printed circuit board, and a fixing frame. The fixing frame includes a receiving portion for receiving the HDD, and a connection portion connected to the receiving portion. The print circuit board is mounted to the connection portion. A connector is mounted to the printed circuit board to be electrically connected to the HDD. An edge connector is formed at a bottom side of the printed circuit board to be inserted into the memory slot.

### BACKGROUND

1. Technical Field

The present disclosure relates to a device for mounting a hard disk drive (HDD).

2. Description of Related Art

Many HDDs are mounted in a frame first. The frame is then mounted in a computer. However, the frame can only hold a limited number of HDDs. If more HDDs are desired in the computer, another frame is needed to hold the additional HDDs. However, the computer has a limited space, thus may not have room for accommodating another frame.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a mounting device, together with two hard disk drives (HDDs).

FIG. 2 is an assembled, isometric view of the mounting device and the HDDs of FIG. 1.

FIG. 3 is a cross-sectional view of FIG. 2, taken along the line III-III.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

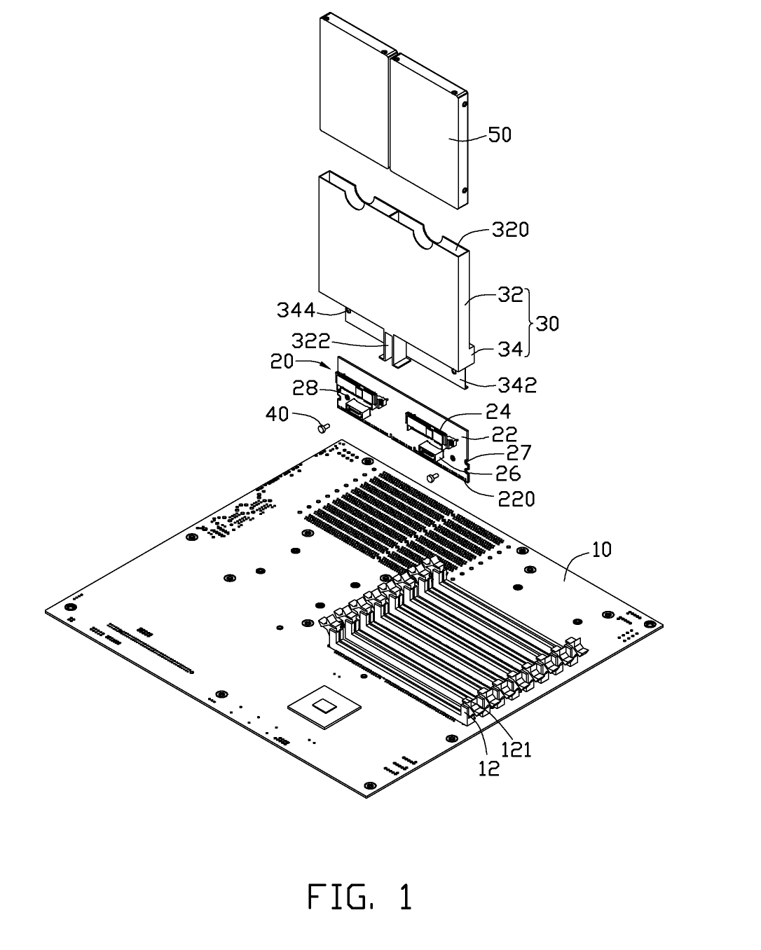

Referring to FIG. 1, an exemplary embodiment of a mounting device is provided for mounting two hard disk drives (HDDs) 50. The mounting device includes a motherboard 10, a printed circuit board 20 and a fixing frame 30.

A plurality of memory slots 12 is mounted on the motherboard 10. Each memory slot 12 includes two latches 121 pivotably connected to opposite ends of the memory slot 12.

The print circuit board 20 includes a main plate 22 having a same form as a memory card, two L-shaped connectors 24 extending forward and then upward from a front side surface of the main plate 22, and two interfaces 26 mounted to the main plate 22 below the connectors 24. A cutout 27 is defined in each of opposite ends of the main plate 22. Two through holes 28 are defined in the main plate 22. An edge connector 220 is formed at a bottom side of the main plate 22.

The fixing frame 30 includes a receiving portion 32 and a connection portion 34 connected to a rear side of the receiving portion 32 and adjacent to a bottom of the receiving portion 32. The receiving portion 32 defines two receiving spaces 320 extending through a top and a rear portion of the bottom of the receiving portion 32. Two L-shaped legs 322 perpendicularly extend down from a front side of the bottom of the receiving portion 32 opposite to the connection portion 34. Bottom ends of the legs 322 opposite to the receiving portion 32 perpendicularly extend away from each other. An L-shaped supporting piece 342 extends down from the connection portion 34 and then extends rearward. Two threaded holes 344 are defined in the supporting piece 342.

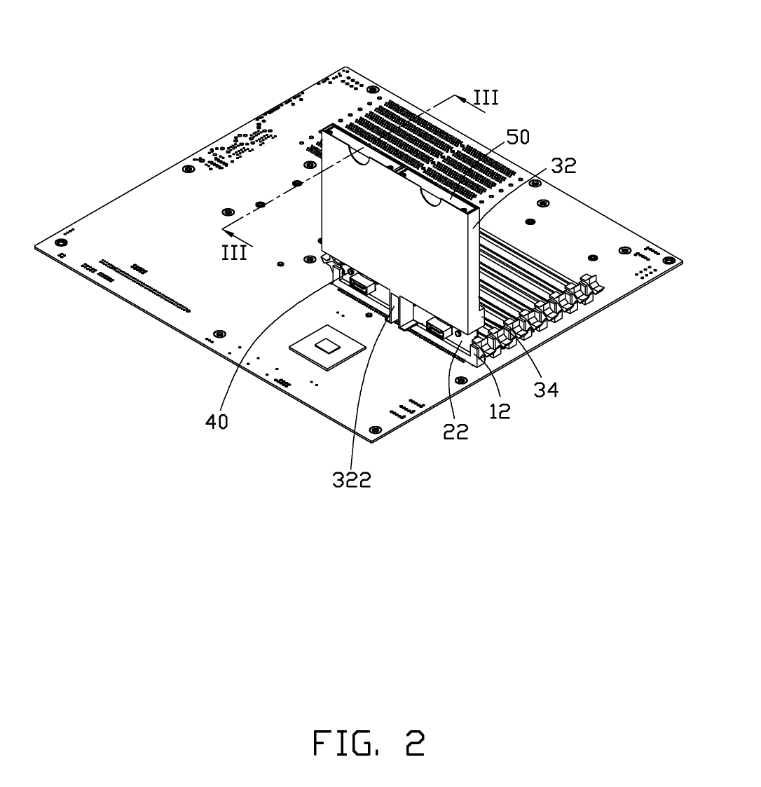

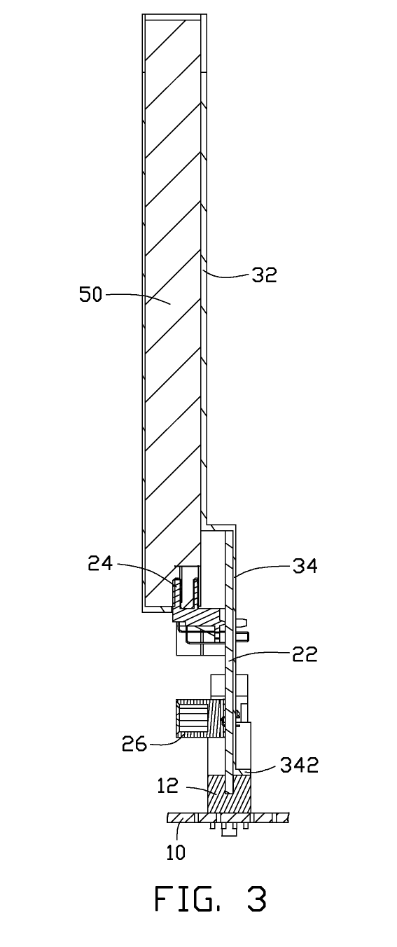

Referring to FIGS. 2 and 3, in assembly, the printed circuit board 20 is attached to a front side of the supporting piece 342 behind the legs 322. Upper portions of the connector 24 are inserted into the corresponding receiving spaces 320 from the rear portion of the bottom of the receiving portion 32. Two screws 40 extend through the through holes 28 and then are respectively screwed into the threaded holes 344, to fix the printed circuit board 20 to the frame 30.

The HDDs 50 are respectively received in the receiving spaces 320, and are supported on a front portion of the bottom of the receiving portion 32. The HDDs 50 are electrically connected to the corresponding connectors 24.

In use, the latches 121 of one of the memory slots 12 are pivoted away from each other. The edge connector 220 of the printed circuit board 20 is then inserted into the memory slot 12, until bottom ends of the legs 322 and the supporting piece 342 are supported on opposite sides of top surfaces of the memory slot 12. The latches 121 are then rotated back to engage in the corresponding cutouts 27. Two cables (not shown) are respectively inserted into the interfaces 26 and are connected to the motherboard 10, thereby transmitting signals between the HDDs 50 and the motherboard 10 through the printed circuit board 20.

The mounting device can advantageously utilize an unused memory slot 12 and make use of the space above the unused memory slot 12 for fixing the HDD 50.

Screws may be provided for extending through a sidewall bounding each receiving space 320 and then engaging in a corresponding one of the HDDs 50, to fix the HDD 50 in the corresponding receiving space 320.

In another embodiment, a cover may be mounted to a top of the receiving portion 32 to fix the HDDs 50 in the corresponding receiving spaces 320.

In another embodiment, a receiving space 320, a corresponding connector 24 and a corresponding interface 26 may be omitted.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting a hard disk drive (HDD), comprising:
a motherboard comprising a memory slot;
a printed circuit board comprising an edge connector detachably inserted in the memory slot, and a connector; and
a fixing frame comprising a receiving portion for receiving the HDD, and a connection portion connected to the receiving portion and the printed circuit board; wherein the connector is electrically connected to the HDD in response to the HDD being received in the receiving portion.

2. The mounting device of claim 1, wherein the connection portion comprises a supporting piece abutting a top surface of the memory slot.

3. The mounting device of claim 2, wherein the supporting piece is substantially L-shaped extending from a bottom of the receiving portion.

4. The mounting device of claim 1, wherein the receiving portion comprises a leg extending from a bottom of the receiving portion and abutting a top surface of the memory slot.

5. The mounting device of claim 4, wherein the leg is substantially L-shaped.

6. The mounting device of claim 1, wherein an interface is mounted on the printed circuit board to be electrically connected to the motherboard.

7. The mounting device of claim 1, wherein the receiving portion defines a receiving space extending through a top and a part of a bottom of the receiving portion, the receiving space receives the HDD, the rest part of the bottom of the receiving portion supports a bottom of the HDD.

8. The mounting device of claim 7, wherein the connector extends out from a side surface of the printed circuit board and then extends upward to be electrically connected to the HDD.

9. The mounting device of claim 1, wherein the printed circuit board defines a cutout in each of opposite ends, the memory slot comprises two pivotable latches to detachably engage in the corresponding cutouts of the printed circuit board.

10. The mounting device of claim 1, wherein the receiving portion comprises two substantially L-shaped legs perpendicularly extending down from the receiving portion, distal ends of the legs extend away from each other.
